(19) United States
(12) Patent Application Publication
(10) Pub. No.: US 2009/0019389 A1
(43) Pub. Date: Jan. 15, 2009

(54) System and method for providing visual markers in electronic documents

(76) Inventor: Andreas Matthias Aust, Princeton, NJ (US)

Correspondence Address: Joseph J. Laks;Thomson Licensing LLC, 2 Independence Way, Patent Operations, PO Box 5312, PRINCETON, NJ, 08543, US

(21) Appl. No.: 11/658,459

(22) PCT Filed: Jul. 29, 2004
(86) PCT No.: PCT/US2004/024524

§ 371 Date: Jan. 25, 2007

(51) Int. Cl. G06F 3/048

(52) U.S. Cl. 715/786

(57) ABSTRACT

A user 10 reads an electronic document 200 stored in a storage 300 using an electronic document reading system 100. A visual marker creation and placement system generates and positions a visual marker within text portions of the ED 200 that provide visual reference particularly when scrolling or by browsing the electronic document. A method, system and/or computer program product for presenting an electronic document thus provides one or more visual markers relative to text portions of the electronic document with the one or more visual markers maintaining a fixed position relative to the text during display and scrolling of the electronic document. By providing a fixed position visual reference, the user is better able to keep one's place in the electronic document, both when the electronic document is static and when scrolling through the electronic document.

### FIELD OF THE INVENTION

The invention disclosed herein relates to a system and method for creating visual markers in electronic documents for readers of the electronic documents, especially useful as visual references during a scrolling operation while viewing electronic documents.

### BACKGROUND OF THE INVENTION

Even though books, magazines and other documents may be readily available in electronic form, readers often prefer to read such materials in conventional printed form. One reason for this preference is that textual content in electronic form often lacks the visual cues present in a printed document that help a reader remember the locations of passages within the document. For example, in a printed document, each page may have a particular layout that is subliminally remembered by the reader as the document is read so that, later on, the reader can locate particular passages of text by browsing through the document for those pages having layouts that the reader remembers as being associated with the desired text. Various aspects of a printed page's layout may be subliminally remembered by a reader and used by the reader later on to locate particular passages, including, for example, a picture or other graphic, the particular position on the page of the picture or graphic, folded paper corners, handwritten notes or sketches.

In electronic documents, however, text is often presented plainly and without the graphics and other items described above that may serve as visual aids for the reader. This is especially the case where the electronic document is being presented in a memory limited environment, e.g., with a small, handheld electronic device. Consequently, when reading electronic documents without distinctive page layouts, readers often have a greater difficulty in locating particular passages than when reading conventional printed documents.

It is particularly difficult for the reader to keep one's place in an electronic document when scrolling through an electronic document. The electronic document is typically presented very quickly. When presented on a small handheld electronic device such as a PDA, pages of information of the electronic document may appear and disappear from the display quite rapidly, thereby making it difficult to keep one's place. A reader may also have difficulty maintaining focus on a particular word or sentience of the text as the text is being scrolled.

It is thus an object of the present invention to provide a system, method and/or device that presents an electronic document in which it is easy to track or maintain one's place in the electronic document, especially during scrolling operation.

### SUMMARY OF THE INVENTION

The invention provides a method, system and/or computer program product for presenting an electronic document and providing one or more visual markers relative to text portions of the electronic document with the one or more visual markers maintaining a fixed position relative to the text when scrolling. By providing a fixed position visual reference, the user is better able to maintain one's place in the electronic document, both when the electronic document is static and when scrolling through the electronic document.

According to the present invention, in response to a user request, an electronic document having text portions included therein is obtained. A portion of the electronic document is displayed on a display device. A visual marker is generated, placed and displayed in the displayed portion of the electronic document in response to activation of a scroll mode of the display device, the visual marker maintaining a fixed position within the electronic document during a scroll mode.

The visual marker may be removed after deactivation of the scroll mode. Such removal may be immediate or after a predetermined time period or delay. The visual marker may take different forms such as a horizontal line between selected lines, a symbol or other indication at a margin of the text portion, and/or visually altering text to be different from surrounding text (e.g. bold, italics, color, etc.).

The creation and placement of the visual markers may be automatically generated or optionally may be manually generated through a user visual marker selection mode and/or interface. Automatic visual marker generation may optionally allow user selection of various parameters for the type of visual marker to be inserted and/or the positioning thereof within the displayed text. Manual generation and placement is accomplished in response to user selection of a marker type and/or text position via the user selection mode/interface.

According to an aspect of the present invention, a plurality of visual markers may be automatically generated and positioned within the electronic document when or after the electronic document is obtained with each visual marker maintaining a fixed position within the electronic document especially during scrolling. Thus, rather than waiting for the scroll mode to be initiated by the user, the visual markers are automatically inserted into the electronic document. Display of the plurality of visual markers may occur during scrolling of the electronic document. The positioning or placement of the plurality of visual markers may be automatically generated or may be selectable by the user.

According to another aspect of the present invention, a visual marker may be manually placed by the user in a displayed text portion of the electronic document. Once placed, the visual marker remains fixed in its text location (or as differentiated text itself), while the text automatically scrolls until the visual marker reaches a predetermined position.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram showing an exemplary operating environment/system of an embodiment of the present invention;

FIG. 2 depicts an exemplary page of an obtained electronic document on which visual markers are to be placed in accordance with the principles of the present invention;

FIG. 3 depicts the page of the electronic document of FIG. 2 on which various exemplary visual markers have been placed in accordance with the principles of the present invention;

FIGS. 4A, 4B and 4C depict an exemplary sequential illustration of scrolling operation in accordance with several aspects of the present invention;

FIG. 5 is a flowchart illustrating an exemplary manner of operation of the present invention;

FIG. 6 is a flowchart illustrating another exemplary manner of operation of the present invention;

FIG. 7 is a flowchart illustrating yet another exemplary manner of operation of the present invention;

FIG. 8 is a flowchart illustrating still another exemplary manner of operation of the present invention;

FIG. 9 is a flowchart illustrating a further exemplary manner of operation of the present invention; and

FIG. 10 is a flowchart illustrating a yet further exemplary manner of operation of the present invention.

### DETAILED DESCRIPTION

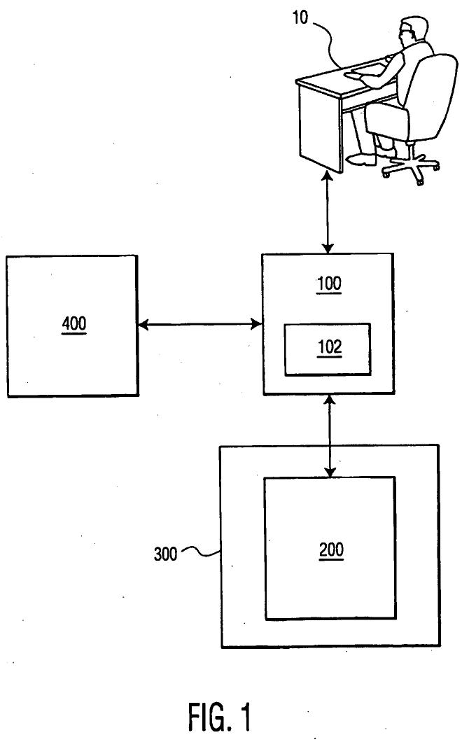

The preferred embodiments of a method, system, and article of manufacture containing software programs in accordance with the present invention is described with reference to the drawings in FIGS. 1-10.

FIG. 1 is a block diagram showing the operating environment of an embodiment of the present invention. A user 10, e.g., a person wishing to read an electronic document, communicates with an Electronic Document Reading (“EDR”) System 100, which may comprise any computer system capable of presenting electronic documents, such as Electronic Document 200, to user 10. For example, EDR System 100 may comprise a personal computer executing a word processing program or a document presentation program such as, Adobe Acrobat® and Adobe Acrobat Reader®. Alternatively, EDR System 100 may comprise, for example, a handheld electronic device with electronic document reader software, such as, a PDA or an RCA brand Gemstar eBook™ from Thomson Consumer Electronics, Inc.

Electronic Document 200 may comprise any computer readable file containing text or text portions that are of a format that is compatible with EDR System 100. For example, Electronic Document 200 may comprise a word processing file, an Adobe® PDF file, a file of the Gemstar eBook Format™, or a file of ASCII format. Also, Electronic Document 200 may be stored in a Storage 300 that is accessible to EDR System 100. Storage 300 may comprise any type of persistent data storage such as, for example, a magnetic disk drive, an optical disk drive, or flash memory. Storage 300 may be physically part of the EDR System 100, such as within the RCA brand Gemstar eBook™ or may be separate therefrom but connectable thereto such as via the Internet or by other means.

In an embodiment of the present invention, the Visual Marker Creation (“VMC”) System 400 may comprise any computer system capable of creating or generating, placing or positioning, and causing display (via display 102 associated with or a part of the EDR System 100) of visual markers in Electronic Document 200 that maintain a fixed position within Electronic Document 200 such as during scrolling thereof and/or thereafter if desired or enabled. The creation/generation, placing/positioning, may be accomplished without any manual intervention (automatically), may be totally manual in terms of implementation parameters as via options to a user, or be a combination of both. The further feature, functions and/or operation of the present invention will be described more fully below.

As shown in FIG. 1, VMC System 400 is in communication with EDR System 100. As described further below, VMC System 400 communicates with EDR System 100 to obtain information regarding Electronic Document 200 and also information regarding the presentation by EDR System 100 of Electronic Document 200 to the user 10. In a preferred embodiment, VMC System 400 comprises computer code allowing it to accomplish this communication with EDR System 100.

In a preferred embodiment, VMC System 400 also comprises computer code to allow it to function in the manner described herein, particularly to place on or more visual markers in the electronic document particularly when in a particular operating mode. For example, as described below, one type of visual marker that may be created and placed in Electronic Document 200 by VMC System 400 includes computer generated graphics or symbols. In that example, VMC System 400 comprises computer code allowing it to create computer generated graphics and place the graphics in the text of Electronic Document 200.

The logical structure of an electronic document may be defined, and consequently ascertained by VMC System 400, in a number of ways depending on the format of the document. For example, some electronic document formats, such as word processing documents, may include logical structure data within each document that specifies, based on their logical structure, e.g., each paragraph, page, chapter, or section. For other electronic document formats that do not contain such logical structure data, such as, for example, ASCII formatted documents, logical structure may be determined based on the textual content, e.g., each indentation may indicate a new paragraph, a blank space of two or more lines may indicate a new page, a string of text beginning with a number and a period followed by a blank space of two or more lines may indicate a new section, and a string of underlined text followed by a blank space of two or more lines may indicate a new chapter.

The term “computer system” here is used broadly to mean computer hardware and computer software or computer software only. In FIG. 1 EDR System 100, Storage 300, and VMC System 400 are shown as distinct systems. However, it should be understood that some or all of EDR System 100, Storage 300, and VMC System 400 may be co-resident on the same computer hardware. For example, EDR System 100 may comprise a PC with a word processing or document presentation program and VMC System 400 may comprise computer software installed on the same PC as a plug-in to the word processing or document presentation program. In another example, such as where EDR System 100 comprises a handheld electronic device with electronic document reader software, VMC System 400 may comprise computer code that is integrated with code of the electronic document reader software.

The VMC System 400 and the visual marker creation and placement process of the present invention may be initiated in a number of different circumstances. For example, EDR System 100 may automatically initiate VMC System 400 after EDR System 100 receives a request from user 10 to read Electronic Document 200 and loads this document into memory.

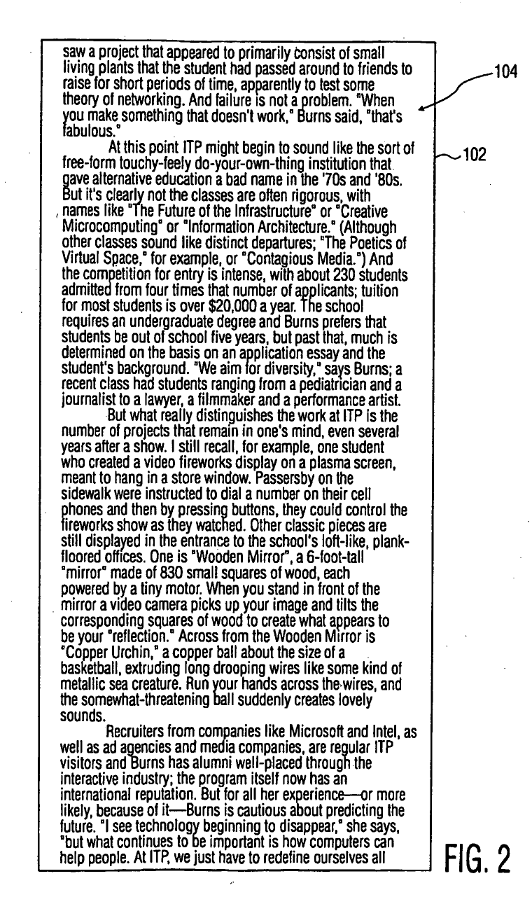

In any manner that the Electronic Document 200 has been obtained by EDR System 100, the EDR System 100 is operable to provide portions (as much as will fit) of the electronic document on the display 102, thus there is the need to scroll through the document in order to read the entire document. An exemplary portion of text 104 from the electronic document 200 on the display 102 is depicted in FIG. 2. This shows a typical display of text without the benefit yet of the addition of fixed position visual markers. Moreover, the depiction of text 104 in FIG. 2 may also be that before any visual markers are displayed on the display 102, but which have already been generated and whose positions have already been determined when obtaining the electronic document as explained further below.

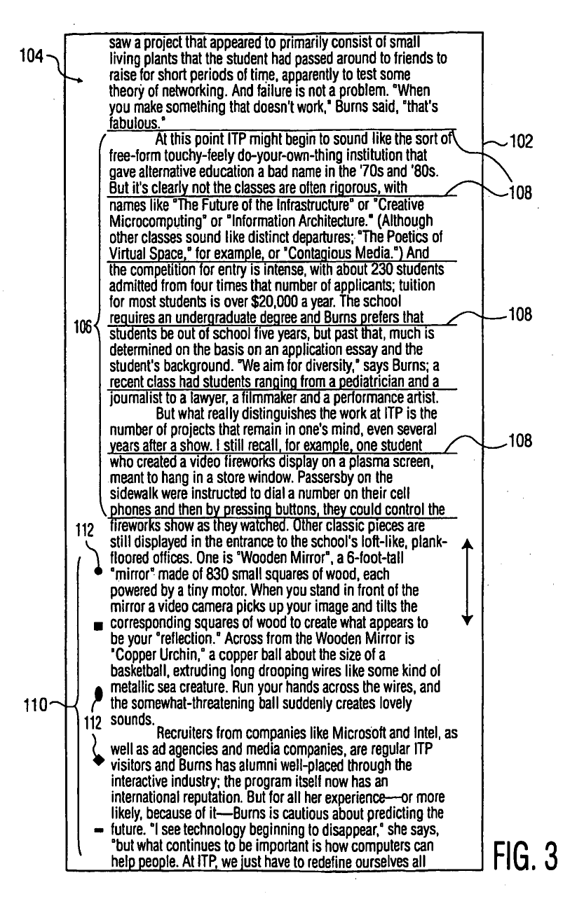

In accordance with one aspect of the principles of the present invention, and referring to FIG. 3, once the text 104 is displayed one or more visual markers may be automatically generated and placed within the text. In FIG. 3, two distinct styles of visual markers are illustrated one style within section 106 of the text 104 and the other style within section 110 of the text 104. In section 106, the visual marker consists of underlining 108 that may or may not include highlighting the text over the underlining. In section 110, the visual marker consists of symbols or graphics 112 that are placed at the margin of the text. Other manners of providing visual markers may be provided such as via italics, bold, color, various types of underlining, other graphics and/or symbols all of which provide a distinction between the visually marked text and surrounding text. In both cases, however, the visual markers are preferably, but not necessarily, provided at regular intervals within or along the text 104 such as at a predetermined number of evenly spaced positions. Additionally, a visual marker may constitute a single line (underlining one or more words within a text line) or symbol, or a plurality of lines or symbols. A plurality of visual markers constitutes more than one visual marker.

The EDR 100 may provide the user the option, selection or ability to choose the type or characteristic of visual marker to be used while still automatically inserting same into the electronic document. The EDR 100 may also provide the user the option, selection or ability to determine where to place the visual markers (rather than such placement or positioning being automatic or determined by the EDR 100) in addition to or in place of automatic determination.

Before the text 104 is scrolled or scrolling has been activated (see FIG. 2), there preferably are no visual markers present within or adjacent (collectively, within) the text. Once scrolling is activated or initiated by the user, the visual marker or markers are displayed (see FIG. 3). According to aspect of the present invention, once scrolling is deactivated (scrolling stops), the visual markers are preferably, but not necessarily, removed. The removal of the visual markers may not, however, be immediate upon the cessation of scrolling. Removal of the display of the visual markers may be accomplished only after a period of time or a time delay. Such time period or delay may be predetermined automatically by the EDR 100 or may be a selectable option for the user in which various time delays may be chosen.

When the text is scrolled, as represented by the double-headed arrow, the visual marker or markers move along with the text in the original position in which they were placed. In this regard, the visual marker or markers are fixed in position (fixed position marker(s)). The EDR 100 may also automatically generate and position, but not display, a plurality of visual markers after the electronic document is obtained. Display of a visual marker or of the plurality of visual markers may be accomplished only after initiation of scrolling or when the EDR 100 is in a scroll or scrolling mode.

The EDR 100 may also allow user control of the selection of marker location within the electronic document. Such selection may include the ability to provide a visual marker at a middle line, bottom line or top line of the text portion being displayed when activated. Last position of the cursor may also be selected. The EDR 100 may provide for placement of visual markers at regular or irregular intervals in the text. For example, the EDR 100 may provide for visual markers evenly spaced at the margin or within the text. The EDR 100 may also provide for the same type of visual marker or vary the visual markers along the text. The user may have the option of selecting the characteristic of the interval as well as the type of visual marker or markers.

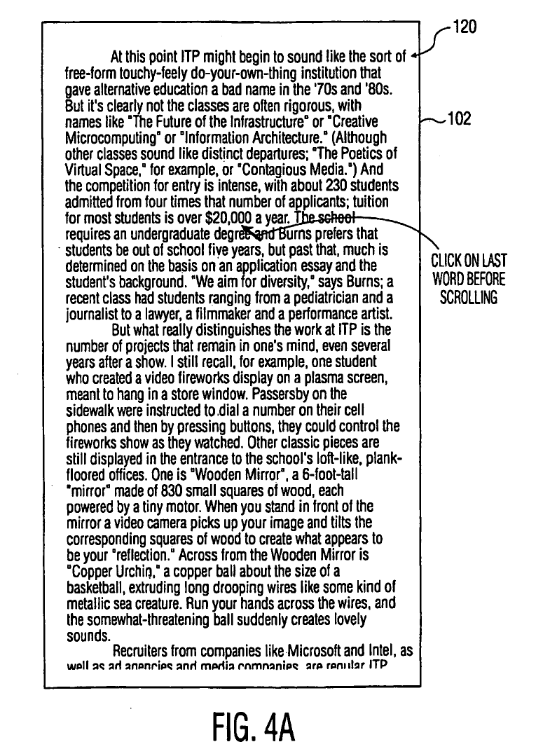

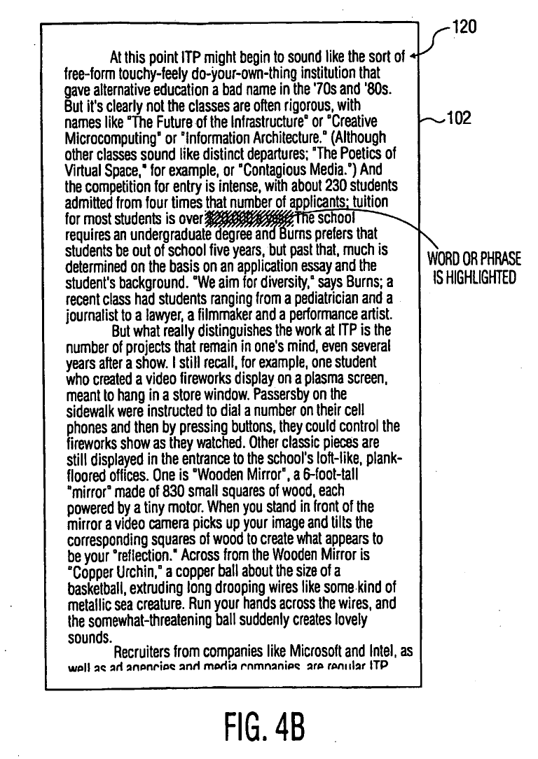

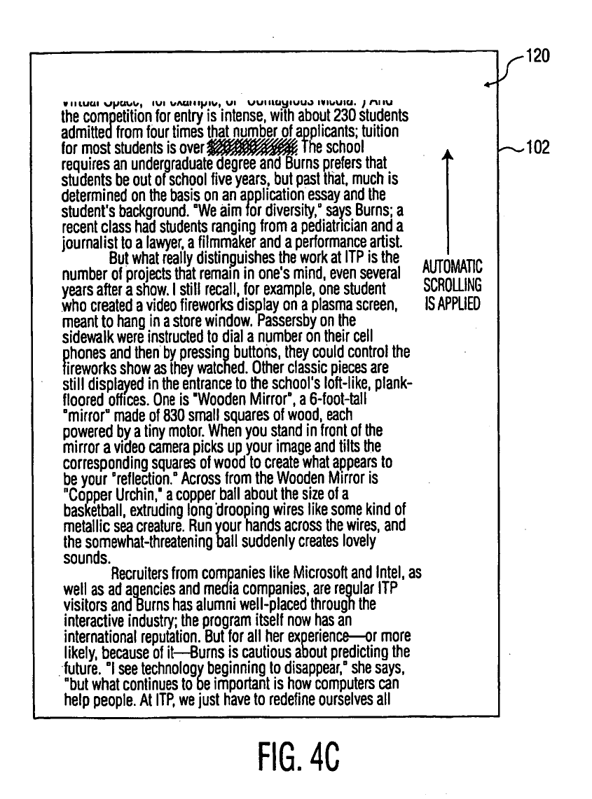

Referring to FIGS. 4A, 4B and 4C, there is depicted a sequence illustrating several manner of operation of the EDR 100. One manner of operation is user selection of visual marker location (placement) and scrolling. In FIG. 4A, a text portion 120 is depicted with a cursor (arrow) on the display 102. The EDR 100 is in a user visual marker selection mode (rather than in an automatic visual marker mode) such that the user may select one or more characteristics of one or more visual markers for generation and placement/positioning within the text portion 120. FIG. 4A depicts user placement of the cursor and selection of a particular word for use as/with a visual marker. Clicking on the word “$20,000” creates a visual marker as shown in FIG. 4B. In this instance the user has selected highlighting or background color change (text color change or text characteristics may also be a visual marker option). As scrolling occurs, as in FIG. 4C, the highlighted text moves along with the text 120. Another word at the bottom of the display 120 may be selected for a visual marker once the previous visual marker has scrolled beyond the display 120. The sequence of FIGS. 4A, 4B and 4C illustrates the fixed position nature of the present visual marker or markers once placed within the text portion.

Another manner of operation illustrated by FIGS. 4A, 4B and 4C is an automatic scrolling feature or function of the EDR 100. This feature may include the same type of user options as hereinbefore discussed as well as the ability to enable or disable the feature. The automatic scrolling feature begins with the EDR 100 allowing the user to select a particular position, location, text line or text word (as in the present case) through use of a cursor (represented by the arrow). FIG. 4A depicts user selection of the visual marker by placement of the cursor on the particular word “$20,000”. This creates a visual marker as shown in FIG. 4B. The EDR 100 may also optionally allow the user to select visual marker characteristics. In this instance the user has selected highlighting or background color change (text color change, text characteristics may also be a visual marker option, as well as the placement of a graphic or symbol in a margin of the text). Once the visual marker has been selected, the EDR 100 commences automatic scrolling. The automatic scrolling may stop the text when the highlighted text (visual marker) reaches a predetermined position. In FIG. 4C, this predetermined position is the top of the display 102. The EDR 100 may allow the user the option to select the predetermined scroll ending position as well as other scroll parameters.

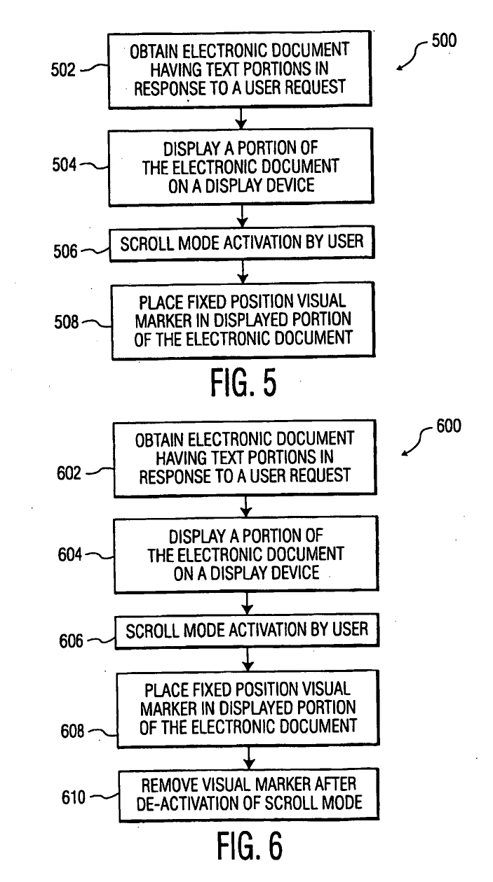

Referring to FIG. 5, there is depicted a flowchart, generally designated 500, illustrating an exemplary manner of operation of the present invention. It should be appreciated that the exemplary manner of operation of the present invention as illustrated in FIG. 5 may be the only mode of operation of the present invention or may be one of several modes of operation of the present invention, other exemplary modes of operation of which are illustrated in connection with the flowcharts of FIGS. 6-10 as described herein.

In step 502, an electronic document having text portions therein is obtained in response to a request by a user to obtain an electronic document. In step 504, a portion of the electronic document is displayed on a display device. In step 506, a scroll mode is activated by the user in order for the user to see the portions of the electronic document that are not displayed on the display device. In step 508, a fixed position visual marker such as described above is generated and placed into or adjacent the displayed text on the display. Preferably, but not necessarily, a fixed position visual marker is placed after every full screen of text has scrolled to provide a visual reference for the user on every page (as defined by the display size). Of course, more than one visual marker may be provided on a particular display screen.

Referring to FIG. 6, there is depicted a flowchart, generally designated 600, illustrating another exemplary manner of operation of the present invention. Again, it should be appreciated that the exemplary manner of operation of the present invention as illustrated in FIG. 6 may be the only mode of operation of the present invention or may be one of several modes of operation of the present invention, other exemplary modes of operation of which are illustrated in connection with the flowcharts of FIGS. 5 and 7-10 as described herein.

In step 602, an electronic document having text portions therein is obtained in response to a request by a user to obtain an electronic document. In step 604, a portion of the electronic document is displayed on a display device. In step 606, a scroll mode is activated by the user in order for the user to see the portions of the electronic document that are not displayed on the display device. In step 608, a fixed position visual marker such as described above is generated and placed into or adjacent the displayed text on the display. Again, preferably, but not necessarily, a fixed position visual marker is placed after every full screen of text has scrolled to provide a visual reference for the user on every page (as defined by the display size). Of course, more than one visual marker may be provided. In step 610, the visual marker (any or all visual markers) is removed from the text of the electronic document when or after the scroll mode has been deactivated (i.e. when the user stops scrolling). The removal of the visual marker may not be immediate once scrolling has ceased. The visual marker may be removed from the display after a predetermined time period or delay following the deactivation or cessation of scrolling. The amount of delay may be predetermined or may be a selectable user option.

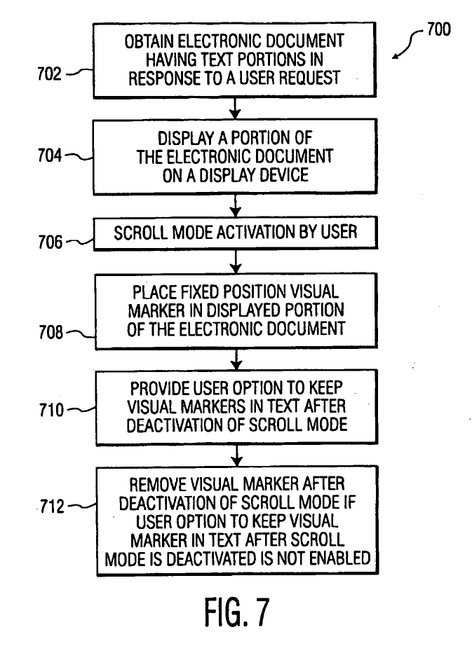

Referring to FIG. 7, there is depicted a flowchart, generally designated 700, illustrating another exemplary manner of operation of the present invention. Again, it should be appreciated that the exemplary manner of operation of the present invention as illustrated in FIG. 7 may be the only mode of operation of the present invention or may be one of several modes of operation of the present invention, other exemplary modes of operation of which are illustrated in connection with the flowcharts of FIGS. 5-6 and 8-10 as described herein.

In step 702, an electronic document having text portions therein is obtained in response to a request by a user to obtain an electronic document. In step 704, a portion of the electronic document is displayed on a display device. In step 706, a scroll mode is activated by the user in order for the user to see the portions of the electronic document that are not displayed on the display device. In step 708, a fixed position visual marker such as described above is generated and placed into or adjacent the displayed text on the display. Again, preferably, but not necessarily, a fixed position visual marker is placed after every full screen of text has scrolled to provide a visual reference for the user on every page (as defined by the display size). Of course, more than one fixed position visual marker may be provided. In step 710, the user is provided with the option to keep one or more fixed position visual markers in the text (i.e. displayed with the text) after deactivation of the scrolling mode (i.e. cessation of scrolling). In step 712, the visual marker (any or all visual markers) is removed from the text of the electronic document when or after the scroll mode has been deactivated (i.e. when the user stops scrolling) if the option to keep the visual marker in the text after scroll mode deactivation is not enabled by the user. Again, the removal of the visual marker may not be immediate once scrolling has ceased. The visual marker may be removed from the display after a predetermined time period or delay following the deactivation or cessation of scrolling. The amount of delay may be predetermined or may be a selectable user option.

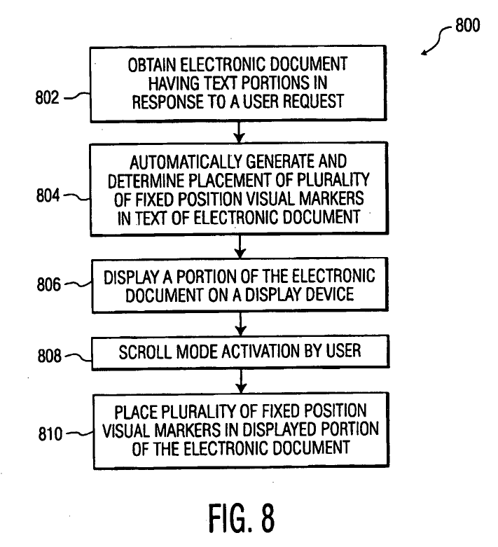

Referring to FIG. 8, there is depicted a flowchart, generally designated 800 illustrating another exemplary manner of operation of the present invention. Again, it should be appreciated that the exemplary manner of operation of the present invention as illustrated in FIG. 8 may be the only mode of operation of the present invention or may be one of several modes of operation of the present invention, other exemplary modes of operation of which are illustrated in connection with the flowcharts of FIGS. 5-7 and 9-10 as described herein.

In step 802, an electronic document having text portions therein is obtained in response to a request by a user to obtain an electronic document. In step 804, a plurality of fixed position visual markers are automatically generated and placement (position) determined, but not yet displayed, within the text of the electronic document. The type of visual markers may be automatically decided or may be a user selectable option. The types and placement of the fixed position markers are as described above. Thereafter, in step 806, a portion of the electronic document is displayed on a display device. In step 808, a scroll mode is activated by the user in order for the user to see the portions of the electronic document that are not displayed on the display device. In step 810, the plurality of fixed position visual markers are placed in the display portion of the text of the electronic document.

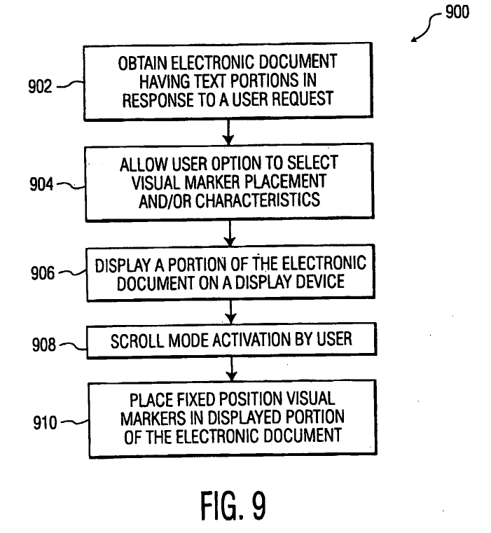

Referring to FIG. 9, there is depicted a flowchart, generally designated 900, illustrating another exemplary manner of operation of the present invention. Again, it should be appreciated that the exemplary manner of operation of the present invention as illustrated in FIG. 9 may be the only mode of operation of the present invention or may be one of several modes of operation of the present invention, other exemplary modes of operation of which are illustrated in connection with the flowcharts of FIGS. 5-8 and 10 as described herein.

In step 902, an electronic document having text portions therein is obtained in response to a request by a user to obtain an electronic document. In step 904, the user is allowed the option of selecting placement or positioning of one or more fixed position visual markers and/or characteristics of one or more of the fixed position visual markers within the text of the electronic document. In step 906, a portion of the electronic document is displayed on a display device. In step 908, a scroll mode is activated by the user in order for the user to see the portions of the electronic document that are not displayed on the display device. In step 910, the one or more fixed position visual markers are placed in the display portion of the text of the electronic document.

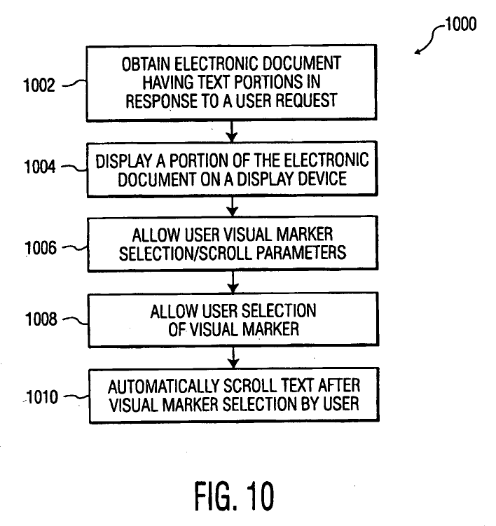

Referring to FIG. 10, there is depicted a flowchart, generally designated 1000, illustrating another exemplary manner of operation of the present invention. Again, it should be appreciated that the exemplary manner of operation of the present invention as illustrated in FIG. 10 may be the only mode of operation of the present invention or may be one of several modes of operation of the present invention, other exemplary modes of operation of which are illustrated in connection with the flowcharts of FIGS. 5-9 as described herein.

In step 1002, an electronic document having text portions therein is obtained in response to a request by a user to obtain an electronic document. In step 1004, a portion of the electronic document is displayed on a display device. In step 1006, the user is optionally allowed to select a type or style of visual marker or the type or style of visual marker (marker parameters) and scroll parameters to be used such as described above. This step is optional, since the visual marker type/style and scroll parameters may be automatically determined by the EDR 100. In step 1008, the user inserts the visual marker into the text. Once the visual marker has been inserted or selected, in step 1010 the text is scrolled to the predetermined scroll position.

It should be appreciated that the various manners of operation of the present invention as exemplified in the above described flowcharts are not necessarily mutually exclusive. Particularly, the various manners of operation may be combined with other manners of operation, such that the present invention embodies one, several or all of the modes (manners) of operation.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

1. A method for presenting an electronic document for viewing on a display device, the method comprising:
obtaining an electronic document having text portions included therein in response to a user request;
displaying a portion of the electronic document on a display device; and
placing and displaying a visual marker in the displayed portion of the electronic document in response to activation of a scroll mode of the display device, the visual marker maintaining a fixed position within the electronic document whereby a visual reference is provided to the user during the scroll mode.

2. The method of claim 1, further comprising:
removing the visual marker after deactivation of the scroll mode.

3. The method of claim 1, wherein the visual marker comprises one of a horizontal line positioned between selected lines of the electronic document, a market positioned at one or more margins of the electronic document, and visually altering portions of the text portions to be different from surrounding portions of the text portions.

4. The method of claim 1, further comprising:
automatically generating and determining placement of a plurality of visual markers within the electronic document when the electronic document is obtained, each one of the plurality of visual markers maintaining a fixed placement within the electronic document.

5. The method of claim 4, wherein placement of the plurality of visual markers within the electronic document is determined such that a predetermined number of evenly spaced visual markers always appear on the display device.

6. The method of claim 1, wherein the visual marker is placed and displayed within the document in response to user selection of a marker location.

7. The method of claim 1, further comprising:
allowing the user to optionally place, display and maintain position of a plurality of visual markers in the electronic document regardless of activation of scroll mode.

8. A system for presenting an electronic document for viewing on a display device, comprising:
means for obtaining an electronic document having text portions included therein in response to a user request;
means for displaying a portion of the electronic document on a display device; and
means for placing and displaying a visual marker in the displayed portion of the electronic document in response to activation of a scroll mode of the display device, the visual marker maintaining a fixed position within the electronic document whereby a visual reference is provided to the user during the scroll mode.

9. The system of claim 8, further comprising:
means for removing the visual marker in response to deactivation of the scroll mode.

10. The system of claim 8, wherein the means for placing and displaying a visual marker in the displayed portion of the electronic document comprises means for placing and displaying a visual marker comprising one of a horizontal line positioned between selected lines of the electronic document, a marker positioned at one or more margins of the electronic document, and visually altering portions of the text portions to be different from surrounding portions of the text portions.

11. The system of claim 8, further comprising:
means for automatically generating and determining placement of a plurality of visual markers within the electronic document when the electronic document is obtained, each one of the plurality of visual markers maintaining a fixed placement within the electronic document.

12. The system of claim 11, wherein the means for automatically generating and determining placement of a plurality of visual markers comprises means for determining placement of the plurality of visual markers within the electronic document such that a predetermined number of evenly spaced visual markers always appears on the display device.

13. The system of claim 8, wherein means for placing and displaying a visual marker in the displayed portion of the electronic document includes means for placing and displaying the visual marker within the document in response to user selection of a marker location.

14. The system of claim 8, further comprising:
means for allowing the user to optionally place, display and maintain position of a plurality of visual markers in the electronic document regardless of activation of scroll mode.

15. An apparatus comprising a computer usable medium having computer readable code embodied therein, the computer readable code, when executed, causing a computer to implement a method for presenting an electronic document for viewing on a display device, the method comprising:
obtaining an electronic document having text portions included therein in response to a user request;
displaying a portion of the electronic document on a display device; and
placing and displaying a visual marker in the displayed portion of the electronic document in response to activation of a scroll mode of the display device, the visual marker maintaining a fixed position within the electronic document whereby a visual reference is provided to the user during the scroll mode.

16. The computer program product of claim 15, wherein the implemented method further comprises:
removing the visual marker after deactivation of the scroll mode.

17. The computer program product of claim 15, wherein, in the implemented method, the visual marker comprises one of a horizontal line positioned between selected lines of the electronic document, a marker positioned at one or more margins of the electronic document, and visually altering portions of the text portions to be different from surrounding portions of the text portions.

18. The computer program product of claim 15, wherein the implemented method further comprises:
automatically generating and determining placement of a plurality of visual markers within the electronic document when the electronic document is obtained.

19. The computer program product of claim 18, wherein, in the implemented method, placement of the plurality of visual markers within the electronic document is determined such that a predetermined number of evenly spaced visual markers always appears on the display device, each one of the plurality of visual markers maintaining a fixed placement within the electronic document.

20. The computer program product of claim 15, wherein, in the implemented method the visual marker is placed and displayed within the document in response to user selection of a marker location.

21. The computer program product of claim 16, wherein the implemented method further comprises:
allowing the user to optionally place, display and maintain position of a plurality of visual markers in the electronic document regardless of activation of scroll mode.

22. A method for presenting an electronic document for viewing on a display device, the method comprising:
obtaining an electronic document having text portions included therein in response to a user request;
displaying a portion of the electronic document on a display device;
allowing user selection of a visual marker on the displayed portion of the electronic document; and
automatically scrolling the electronic document on the display to a predetermined position with respect to the visual marker in response to user selection of the visual marker.

23. The method of claim 22, further comprising:
allowing user selection of the predetermined position before automatic scrolling.

24. The method of claim 22, wherein the predetermined position comprises an uppermost position of the display.
